(19) United States
(12) Patent Application Publication
(10) Pub. No.: US 2004/0026324 A1
(43) Pub. Date: Feb. 12, 2004

(54) Transition metal oxide compositions

(76) Inventor: Victor Luca, New South Wales (AU)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/415,622

(22) PCT Filed: Oct. 31, 2001
(86) PCT No.: PCT/AU01/01402

(30) Foreign Application Priority Data
Oct. 31, 2000 (AU) PR 1137

(51) Int. Cl. C01G 25/02; B01D 15/00

(52) U.S. Cl. 210/660; 423/592.1; 423/608

(57) ABSTRACT

The invention provides transition metal oxide mesophase compositions that include a sulfur-containing anionic surfactant and processes for preparing them. The processes involve conversion of a transition metal oxide precursor to a transition metal oxide mesophase in the presence of a sulfur-containing anionic surfactant templating agent, under conditions effective for formation of a transition metal oxide mesophase composition that includes the surfactant. The invention further provides processes for replacing at least part of the surfactant in such a transition metal oxide mesophase composition with anions. The anions may be anions of one or more oxyacids, thereby producing a transition metal oxide mesophase composition that includes a first transition metal oxide and a lesser amount of a second transition metal oxide dispersed on the first metal oxide.

### FIELD OF THE INVENTION

The invention relates to transition metal oxide mesophase compositions, including ordered transition metal oxide mesophase compositions comprising titania as a major component, to processes for preparing transition metal oxide mesophase compositions, and to processes for at least partially removing anions from an aqueous solution of the anions, by contacting the solution with a transition metal oxide mesophase composition of the invention.

### BACKGROUND OF THE INVENTION

Ordered mesoporous silica (OMS) and the method of making it using surfactant self-assembly has been known since 1992.

Following the discovery of methods of synthesising ordered mesoporous silicates, much effort was directed toward producing mesoporous metal oxides having potential applications in catalysis, ionic and molecular separations, and electro-optics. The excitement generated within the scientific community was also, in part, due to the potential availability of materials with pore sizes beyond the upper limit afforded by microcrystalline zeolites. The largest pore size presently afforded by zeolites having even a reasonable thermal stability is about 14 Å, which is not sufficient to allow the catalytic cracking of high molecular weight hydrocarbons. The new OMS materials can be synthesized with uniform tubular pores that range in size from about 30 to 100 Å. At present there are relatively few oxide materials that can bridge the critical pore size range from 14 to 30 Å. This pore size range is especially important in shape selective catalysis. OMS materials have high surface areas typically exceeding 800 m²/g, possess type IV nitrogen adsorption isotherms with little or no hysteresis, and have extremely narrow pore size distributions.

OMS phases however have a number of drawbacks as far as potential applications are concerned. For example, OMS materials tend to have poor hydrothermal stability and are therefore unsuitable for most applications involving exposure to elevated temperatures. Additionally, although the pore ordering is better than that of conventional silicas, the surface acidity and surface hydroxyl densities are relatively low. Because of this, the pure silica phase has little, if any, ion exchange capacity, and displays little catalytic activity. One way of improving the sorption characteristics and catalytic properties of these ordered mesoporous materials is to substitute more acidic elements for silicon in the pore walls, or to graft other catalytically active metals to the surface of the pores. For instance in U.S. Pat. No. 5,145,816 a method is disclosed for functionalizing the internal surfaces of mesoporous silicas using metal halides, hydrides, alkoxides etc. A large number of studies have been undertaken with this aim.

An alternate route to mesophase materials with enhanced sorption and catalytic properties is to produce transition metal analogues. These materials would have potential application, not just in separations and catalysis, but would also allow the semiconducting nature of many of these oxides to be exploited for possible electro-optical applications. In addition, the ability of many transition metals to exhibit variable valence and high Lewis acidity are important properties in various other applications including catalytic and photocatalytic oxidations as well as electrochemical applications. A particular advantage of a titanium oxide system in photochemical applications is its photochemical stability.

Although there have been many claimed syntheses of transition metal oxide mesophases with tubular porosity, many of these materials do not in fact possess uniform tubular pores, and especially uniform tubular pores that are arranged on an ordered hexagonal or cubic lattice. Furthermore, most of the reported transition metal oxide mesophase materials do not show good thermal stability. For example, U.S. Pat. No. 5,958,367 in the names of Ying et al. claims hexagonally packed mesoporous metal oxides, including titania, designated Ti-TMS1 in the cited patent. However, it has been shown subsequently (Putnam et al., Chem. Mater. 9 2690-2693 (1997)) that Ti-TMS1 materials are in fact lamellar, rather than hexagonally packed. In fact, even FIG. 1 of U.S. Pat. No. 5,958,367 shows only three XRD peaks with d-values of 34.9, 17.46, 11.69 Å which provides very good evidence for the lamellar structure of the material named as Ti-TMS1. Lamellar mesophases have typically poor thermal stabilities.

Accordingly, there is a need for an improved process for the preparation of transition metal oxide mesophase compositions (and especially those of titania) having tubular porosity and enhanced sorption properties and catalytic properties.

### SUMMARY OF THE INVENTION

According to a first embodiment of the invention, there is provided a process for preparing a transition metal oxide mesophase composition including converting a transition metal oxide precursor into a transition metal oxide in the presence of a sulfur-containing anionic surfactant templating agent under conditions effective for the formation of a transition metal oxide mesophase including said anionic surfactant, said process further including replacing at least part of said anionic surfactant in said transition metal oxide mesophase with an anion of one or more oxyacids of one or more metals selected from elements from group Va, VIa, VIIa, VIIIa, IIIb, IVb, Vb and VIb of the periodic table.

Typically, in the process of the first embodiment, the transition metal is a metal selected from the group consisting of Ti, V, Cr, Mn, Fe, Zr, Nb, Mo and W. More typically, the transition metal is titanium.

According to a second embodiment of the invention, there is provided a process for preparing a titanium oxide mesophase composition including converting a titanium oxide precursor into a titanium oxide mesophase composition in the presence of a templating agent under conditions effective for the formation of a titanium oxide mesophase, wherein the templating agent includes a sulfur-containing anionic surfactant, said process further including at least partially removing said anionic surfactant from said titanium oxide mesophase composition by ion exchange.

According to a third embodiment of the invention, there is provided a process for preparing a transition metal oxide mesophase composition including forming a mixture of a first transition metal oxide precursor which includes said transition metal in a first oxidation state X, a sulfur-containing anionic surfactant, and a second transition metal oxide precursor including a transition metal in a second oxidation state Y, wherein X and Y are different, and converting the transition metal oxide precursors to transition metal oxide under conditions effective to form said transition metal oxide mesophase composition.

According to a fourth embodiment of the invention, there is provided a process for preparing a transition metal oxide mesophase composition including forming a solution in an organic solvent of a first transition metal oxide precursor including a transition metal in a first oxidation state X, a sulfur-containing anionic surfactant, and a second transition metal oxide precursor including a transition metal in a second oxidation state Y, wherein X and Y are different, converting the transition metal oxide precursors to transition metal oxide under conditions effective to form a transition metal oxide mesophase including said anionic surfactant, and at least partially removing the anionic surfactant from the transition metal oxide by ion exchange to form the transition metal oxide mesophase composition.

Typically, in the processes of the third and fourth embodiments the difference between X and Y is +2, +1 or −1. In the processes of the third and fourth embodiments, the transition metals in oxidation states X and Y may be the same or different.

Typically, in the processes of the first to third embodiments the step of converting the metal oxide precursor(s) to metal oxide is carried out in an organic solvent.

According to a fifth embodiment of the invention, there is provided a process of the second or fourth embodiments, wherein the anionic surfactant is removed by ion exchange with a solution of one or more oxyacids of metals from group Va, VIa, VIIa, VIIIa, IIIb, IVb, Vb and VIb of the periodic table, or a salt thereof. Typically, in this embodiment, the oxyacid is an oxyacid of a transition element. The deposition of a coating of a transition metal oxyacid on the internal pore surfaces serves to functionalize the surfaces, stabilize the structure, and reduce the pore size into a useful range which may be within the mesoscopic range or smaller.

In the processes of the first to fifth embodiments, the transition metal oxide mesophase composition is typically a poorly ordered or ordered transition metal oxide mesophase composition. In one form of these embodiments, the templating agent is a complex or salt of the transition metal and the anionic surfactant.

According to a sixth embodiment of the invention, there is provided a transition metal oxide mesophase composition when prepared by the process of any one of the first to fifth embodiments.

Optionally, the transition metal oxide mesophase composition of the invention may be calcined. A transition metal mesophase composition produced by the process of the second, third or fourth embodiment may be calcined to yield a porous nano particulate mesophase. Removal of the surfactant by ion exchange using one or more anions of metal oxyacids from group Va, VIa, VIIa, VIIIa, IIIb, IVb, Vb or VIb of the periodic table, as in the first and fifth embodiments, yields mesophases with uniform tubular porosity similar to, but less ordered than, that found in OMS materials. Typically, the transition metal oxide mesophase composition of the sixth embodiment is an ordered or poorly ordered transition metal oxide mesophase composition.

According to a seventh embodiment of the invention, there is provided a transition metal oxide mesophase including titania as a major component, said metal oxide mesophase exhibiting an X-ray diffraction pattern which contains at least one peak and being capable of sorbing at least about 0.02 atoms of a transition element per atom of titanium when contacted with a solution containing anions of an oxyacid of said transition element, at a pH at which said anions are substantially monomeric.

Typically, the metal oxide mesophase composition of the seventh embodiment is capable of sorbing at least about 0.03 atoms of a transition element per atom of titanium when contacted with a solution containing anions of an oxyacid of said transition element, at a pH at which said anions are substantially monomeric. More typically, the metal oxide mesophase composition of the seventh embodiment is capable of sorbing at least about 0.04 atoms, even more typically at least about 0.05 atoms, still more typically at least about 0.06 atoms and yet more typically at least about 0.07 atoms of a transition element per atom of titanium when contacted with a solution containing anions of an oxyacid of said transition element, at a pH at which said anions are substantially monomeric.

According to an eighth embodiment of the invention, there is provided a transition metal oxide mesophase composition including a first transition metal oxide and a lesser amount of a second transition metal oxide dispersed on said first metal oxide, which transition metal oxide mesophase exhibits an X-ray diffraction pattern which contains at least one peak and is thermally stable to at least 400° C.

According to a ninth embodiment of the invention, there is provided a transition metal oxide mesophase composition including a sulfur-containing anionic surfactant.

In one form of the composition of the ninth embodiment, the transition metal oxide is titania or a mixed oxide comprising titania as a major component.

According to a tenth embodiment of the invention there is provided a process for at least partially removing anions from an aqueous solution of said anions, comprising contacting said aqueous solution with a transition metal oxide mesophase composition of the ninth embodiment for a time sufficient to decrease the concentration of said anions in said aqueous solution.

### BRIEF DESCRIPTION OF THE DRAWINGS

FIG. 1 presents X-ray diffraction patterns of titania mesophase materials (a) dried at 60° C. and (b) after calcination at 500° C. in air. The numbers above the peaks represent the X-ray d-spacings.

FIG. 2 presents X-ray diffraction patterns of (a) uncalcined sodium dodecylsulfate, and the materials described herein as (b) TOM-1, (c) TOM-2, and (d) TOM-3.

FIG. 3 presents the X-ray diffraction pattern of a mixed titania-zirconia mesophase.

FIG. 4 presents X-ray diffraction patterns of (a) TOM-3 dried at 60° C., (b) sample from (a) exchanged using 40 mM sodium molybdate solution, (c) sample from (b) calcined at 400° C. in air, (d) sample from (a) exchanged using 200 mM sodium molybdate solution, and (e) sample from (d) calcined at 400° C.

FIG. 5 is a graph of the nitrogen adsorption/desorption isotherm for titania mesophase exchanged using 40 mM molybdate solution at pH=6.9 and calcined at 400° C.

FIG. 6 is a graph of the nitrogen adsorption/desorption isotherm for titania mesophase exchanged using 40 mM tungstate solution at pH=5.5 and calcined at 400° C.

FIG. 7 is a graph showing the amount of uptake of chromate ions by a titnium oxide mesophase of the invention from an aqueous solution at a pH between 11 and 12 as a function of chromate concentration in the aqueous solution.

FIG. 8 is a graph showing the amount of uptake of Orange II from an aqueous solution by a titanium oxide mesophase of the invention and by a reference titania compound. The graph plots the amount of uptake of Orange II as a function of Orange II concentration in the aqueous solution.

FIG. 9 is a graph showing desorption of Orange II from a titanium oxide mesophase in accordance with the invention, as a function of time, for two different titania mesophase samples that had been dried at different temperatures.

FIG. 10 is a TEM image of a film of titanium oxide mesophase formed on a silicon substrate.

### DETAILED DESCRIPTION OF THE INVENTION

The present invention provides processes for the preparation of transition metal oxide mesophase compositions and surface functionalization of metal oxide compositions. As used herein, the term “mesophase” denotes a phase having a repeat dimension in the mesoscopic range of about 20 to about 100 Å. Typically such materials have a high surface area, usually over 100 m²/g and preferably over 200 m²/g.

Metal oxide compositions of the present invention are distinguished from transition metal oxide compositions which were known prior to this invention, in that the compositions of the present invention have a surface functionality which enables them to sorb significant amounts of anions, either reversibly or irreversibly, depending on the anion. This property enables metal oxide compositions to be prepared which contain, for example, predetermined amounts of an oxide of a second transition metal, in addition to the major metal oxide component, and in which the average pore size may be controlled by controlling the amount of the anion which is sorbed.

Transition metal oxide mesophase compositions of the present invention typically exhibit at least some ordering and contain at least some pores of a generally tubular shape and substantially uniform size. The orientation of the pores may be regular or irregular in the compositions of the present invention.

As used herein, the term “ordered” means that the composition exhibits an X-ray diffraction pattern with sufficient peaks to enable the pattern to be unambiguously indexed on a suitable unit cell. The term “poorly ordered” means that the composition exhibits an X-ray diffraction pattern which contains at least one, and preferably more peaks, but usually insufficient peaks to allow unambiguous indexation.

As used herein, the term “major component” refers to a component which is present in an amount of at least 50 mole %, based on the total of all components present. Similarly, the term “minor amount” refers to an amount which is not more than 50 mole %, based on the total of all components present.

As used herein, the expression “thermally stable” at a particular temperature means that the physical structure, and the porosity, of the material is not substantially changed when the material is heated to at least the stated temperature. Thus, a transition metal oxide mesophase that is thermally stable at a given temperature is one that remains a transition metal oxide mesophase when heated to at least the given temperature.

The metal oxide compositions of the present invention may comprise essentially a single metal or they may comprise two or more metals. Typically, at least a major amount of the metal oxide in the compositions is titania. However, metal oxide mesophase compositions which comprise major amounts of other transition metals such as zirconium, vanadium, tungsten, chromium or manganese are also provided by the processes described herein.

In the processes of the third and fourth embodiments, the first and second metal oxide precursors may each include a single metal, or a mixture of metals. Usually, the metal oxide precursor wherein the metal is in oxidation state Y includes a single metal or more than one metal, and the single metal or one of the metals is usually but not necessarily the same as the metal which is in oxidation state X. For example, the second metal oxide precursor may be a titanium tetraalkoxide, or a mixture of a titanium tetraalkoxide and another metal tetraalkoxide such as zirconium tetraalkoxide, and the first metal oxide precursor may be a complex of titanium in oxidation state m with an anionic surfactant. In mixed systems, in which the metal of the metal oxide precursor which is in oxidation state Y is, or includes, a different metal to that of the metal oxide precursor in oxidation state X, the difference between X and Y may be 1, 2 or 3. For example, one metal oxide precursor may include trivalent titanium, (X=+3) while the other metal oxide precursor is, or includes, an alkoxide such as V(V)-alkoxide or Nb(V)-alkoxide, (Y=+5) or W(VI)-alkoxide (Y=+6). Further examples are mixtures of the dodecylsulfate salt of V(III) (X=+3) with one or both of VO[OCH(CH₃)₂]₃ (Y=+5) and Ti[OCH(CH₃)₂]₃ (Y=+4). Given the teaching herein, other suitable combinations will be apparent to persons of ordinary skill in the relevant art.

In the processes of the invention, the metal oxide precursor may be any metal compound capable of being converted to the corresponding metal oxide under appropriate reaction conditions. Typically, the metal oxide precursor is converted to a metal oxide by hydrolysis. Examples of metal oxide precursors which are capable of being converted to metal oxides on hydrolysis include metal alkoxides and other organometallic compounds such as metal carboxylates (for example acetates) and acetylacetonates, and metal salts, such as metal halides, and mixtures thereof.

Usually, the metal oxide precursor is a metal alkoxide or a mixture of metal alkoxides, such as metal methoxides, ethoxides, propoxides, isopropoxides, butoxides and the like, including mixed alkoxides. Typically, the metal alkoxide is a metal isopropoxide or a metal butoxide.

In the processes of the preferred embodiment of the invention the sulfur-containing anionic surfactant may be any organic molecule having a sulfur-containing anionic head group and a hydrophobic tail. Preferred examples of such molecules are anionic surfactants having a sulfate group as the anionic head group such as alkyl or aryl sulfates. However, alkyl or aryl sulfonates and alkyl or aryl sulfosuccinates may also be used. In these molecules, the alkyl group is the alkyl group of a long chain fatty acid, typically from C₈-C₂₄, more typically from C₁₂-C₁₈. Included within these classes of anionic surfactants are hydroxylated, alkoxylated, polyalkoxylated and other derivatives. Thus, other preferred examples include alcohol ether sulfates, sulfated alkanolamide ethoxylates, sulfated glycerides, and alkyl phenol ether sulfates. Other suitable sulfur-containing anionic surfactants include alcohol ether sulfonates, alkyl benzene sulfonates, alkyl naphthalene sulfonates, sulfonated fatty acids, alkene sulfonates, fatty alcohol ether sulfosuccinates, and sulfosuccinamates. Typically, the surfactant is an alkyl sulfate, wherein the alkyl group is the alkyl group of a long chain fatty acid, typically from C₈-C₂₄, more typically from C₁₂-C₁₈, such as sodium dodecyl sulfate.

Typically, in the processes of the present invention the mole ratio of metal to anionic surfactant (hereinbelow denoted x) is at least about 2, and more typically in the range 2.5 to 4, and still more typically about 3.

The step of converting the metal oxide precursor to metal oxide is typically a hydrolysis step and is usually carried out in an organic solvent since the surfactant salt is insoluble in water. The organic solvent may be any organic solvent in which the metal oxide precursor is soluble and which does not react with the metal oxide precursor in such a way as to prevent metal oxide being obtained from it. Typically, the organic solvent is a lower alcohol, such as methanol, ethanol, isopropanol and the like. More typically, the organic solvent is ethanol. A hydrolysis step may be achieved by the addition of water to the organic solvent after the metal oxide precursor has been dissolved therein. Typically, the water is added in a controlled manner and usually evaporation of the organic solvent occurs simultaneously with the addition of water and the conversion of the metal oxide precursor to the metal oxide, or after the conversion is substantially complete.

Advantageously, the step of converting the metal oxide precursor to the metal oxide is carried out in a controlled manner since the conversion of precursor to metal oxide at too rapid a rate tends to give rise to amorphous products without the desired tubular porosity. Accordingly, when the metal oxide precursor is converted to the metal oxide by hydrolysis, conditions effective for the formation of a transition metal oxide mesophase in the processes of the first to fifth embodiments include conditions whereby the hydrolysis of the precursor is sufficiently slow to inhibit or substantially prevent the formation of amorphous metal oxide. The control of the hydrolysis rate may be effected by the use of an organic solvent containing only a small concentration of water, by the choice of organic solvent utilised, by the use of a metal oxide precursor which is relatively slow to hydrolyse, and/or by the inclusion in the reaction medium of halide ions, typically chloride ions, and/or a chelating agent capable of forming a chelate with the metal oxide precursor. Examples of suitable chelating agents include β-diketones such as acetylacetone and the like.

In the processes of the third and fourth embodiments, the inclusion of a metal oxide precursor in the lower of oxidation states X and Y tends to result in the initial hydrolysis being slower than if all of the metal oxide was in oxidation state Y since lower valent state metal oxide precursors are typically less prone to hydrolysis.

In one form of the process of the third embodiment, the mixture may be regarded as a mixture of two metal oxide precursors in two different oxidation states. One of the metal oxide precursors may be in the form of a salt or complex comprising the metal and the anionic surfactant. For example, the salt may be a salt of a metal with an alkyl sulfate, such as a salt having the stoichiometry of about 3 moles of alkyl sulfate such as dodecyl sulfate to 1 mole of trivalent metal such as titanium in oxidation state III. The salt can optionally include one or more molecules of hydration, but otherwise will typically be substantially dry.

In the processes of the first to fourth embodiments, when the metal oxide composition is first formed, it is formed with inclusion of the anionic surfactant which may subsequently be removed by ion exchange. Thus, in the processes of the second, fourth and tenth embodiments, the anionic surfactant is removed from the metal oxide composition by ion exchange. Such a removal step involves contacting the metal oxide surfactant composition with a solution containing anions capable of displacing all or part of the sulfur containing surfactant. Suitable anionic species include inorganic anions such as sulfate, phosphate, borate, aluminate, etc.; oxyacids of transition metals such as molybdate, vanadate, tungstate, chromate etc.; and organic anions such as anions of lower fatty acids, including formate, acetate, propionate, butyrate etc., or more complex organic anions such as anions derived from organic dyes. The anion may also be a complex inorganic anion such as, for example, ferrocyanide, ferricyanide, Au(CN)₂⁻, Au(Cl)₂⁻, MoO₄²⁻, VO₄²⁻, CrO₄²⁻ and the like. The ion exchange can consist of one, two or more steps. For instance, in an ion exchange which includes two steps the transition metal oxide composition containing the anionic surfactant may, for example, first be contacted with a solution of a salt of a fatty acid to produce a composition which includes fatty acid anions among the transition metal oxide structure, followed by contacting this with a solution containing another anion capable of displacing the fatty acid anions, such as an anion of a transition metal oxyacid. Possible variations on this ion exchange step will be readily apparent to persons of ordinary skill in the relevant art. For example, the transition metal oxide composition containing the anionic surfactant may be first contacted with a solution containing anions of an oxyacid of a first transition element so as to displace the anionic surfactant from the metal oxide matrix, followed by contacting the composition so formed with a solution containing anions of an oxyacid of a second transition element so as to at least partially replace the anions of the oxyacid of the first transition element. Optionally, the resultant composition may be heated, which may cause dissolution of one of the oxides into the other, leading to a mixed oxide mesophase composition in which one or more transition metals is distributed throughout the matrix of the metal oxide composition. The resultant metal oxide composition obtained after replacing the surfactant with one or more transition element oxyacid anions therefore includes one or more transition metals (in the form of oxyacid anions) distributed on the surface of, and possibly to some extent within, the pore walls.

In one form of the process of the second and fourth embodiments, the transition metal oxide composition is washed with a solution containing anions of one or more oxyacids of metals from group Va, VIa, VIIa, VIIIa, IIIb, IVb, Vb and VIb of the periodic table, typically one or more oxyacids of transition elements, which results in substantially complete displacement of the anionic surfactant with the formation of a metal oxide composition which includes the metal(s) from group Va, VIa, VIIa, VIIIa, IIIb, IVb, Vb or VIb dispersed throughout a matrix of the transition metal oxide. The oxyacid may be, for example, an oxyacid of an element selected from Mo, W, Ru, Cr, V and As.

Use, in the ion exchange step, of solutions of oxyacids as described above, results in substantially complete removal of the anionic surfactant molecules from the metal oxide composition leaving accessible porosity and internal pore surfaces coated with a dispersed second element. Prior to this surfactant removal step by ion-exchange, the metal-surfactant composite has negligible surface area and low thermal stability. A thermally stable (to at least 400° C.) mesophase having tubular structure and significant surface area is only generated on surfactant removal and deposition of a coating of the second oxide.

Usually, in the ion exchange step, a mole ratio of the replacement anion to the anionic surfactant in the range of 0.2 to 10 or more, more typically 2 to 10, is used. It is possible to influence and control the pore size of the transition metal oxide by varying this ratio and in this way regulate the amount of second element incorporated into the metal oxide. Thus, if a relatively low mole ratio of oxyacid to organic surfactant is used, the pore size of the resultant transition metal oxide mesophase will be substantially larger than if a relatively high mole ratio of oxyacid to anionic surfactant is used.

The pore diameter of transition metal oxide mesophase compositions of the invention or prepared in accordance with the inventive processes is also affected by (a) choice of solvent for the reaction in which the metal oxide precursor is converted to the metal oxide composition, (b) the type and size of the anionic surfactant, (c) the concentration of metal oxide precursor in the reaction mixture prior to conversion to the metal oxide, (d) the rate of conversion of the metal oxide precursor to the metal oxide, (e) the ratio of metal oxide precursor to anionic surfactant, (g) the temperature and (g) the transition metal or metals utilised. Given the teaching herein, it requires no more than routine experimentation for persons skilled in the art of synthesis of porous metal oxide compositions to arrive at transition metal oxide compositions in accordance with the present invention having a desired pore diameter of up to 50 Å, typically in the range of 30 to 0 Å.

A process in accordance with the present invention for the preparation of titania mesophase will now be described.

### Preparation of Titanium Salt of an Anionic Surfactant

A solution of a salt of titanium in oxidation state III, such as TiCl₃, in an acidic medium is added to an aqueous solution of an alkali metal salt of the anionic surfactant. The mole ratio of anionic surfactant to titanium chloride in this reaction can be in the range 2.5 to 3.5 and is typically 3. The solution of titanium salt usually has a concentration in the range of about 0.5 to 3.0 mol/L, more usually about 1.9 mol/L and is typically made up to this concentration using hydrochloric acid with a concentration between 1 and 2 mol/L, typically about 2.0 mol/L. It is also possible to dissolve the TiCl₃ salt directly in water and add this solution directly to the aqueous surfactant solution. However, the TiCl₃ solution in 2.0 mol/L acid is stable for a longer period under ambient conditions without the generation of oxyhydroxy Ti clusters or precipitates. On addition of the salt of titanium to the salt of the anionic surfactant, a lilac coloured solid precipitates and this is separated within about 10 minutes from the supernatant by filtration or centrifugation and washed with deionised water. The washed solid may be dried by convenient means while avoiding the use of excessive heat. Typically it is freeze-dried.

### Preparation of Metal Oxide Mesophase Composition

The Ti(III)-surfactant salt is dissolved in an organic solvent, typically ethanol, by gentle warming to about 60° C. and then titanium tetraalkoxide solution is added. This gives rise to an intense burgundy coloured solution which is presumably due to Ti³⁺-Ti⁴⁺ electronic interactions. The colour and consistency of this solution remains indefinitely if the temperature is maintained above about 26° C. and air is excluded. To produce a stable mesophase, the mole ratio of titanium tetraalkoxide to surfactant contained in the titanium salt of the surfactant is at least 2, typically in the range 2.5 to 3.5. Concentrations of the titanium tetraalkoxide plus titanium salt of the anionic surfactant in the organic solvent are typically in the range 0.6-0.8 mol/L. At this stage the infusion of water with concomitant evaporation of organic solvent is required. One way of achieving this is to pass water saturated air through or over the burgundy precursor solution causing hydrolysis of the titanium containing species and condensation of the resulting intermediate products to form a metal oxide matrix. That is, air saturated with water vapour continues to be passed through the solution while the solvent evaporates, until gelation is complete. If desired, further evaporation of the solvent may be carried out, and the resulting gel is dried at temperatures between 30 and 70° C. or it can be freeze- or vacuum-dried. Other drying techniques are also possible. The dried gel can then be ground to a powder, and if desired, washed with a solution containing at least 2 moles of a suitable anion per mole of anionic surfactant incorporated in the reaction mixture. Washing is typically carried out by dispersing the gel in water by stirring, allowing the gel to resettle, and then centrifuging to recover the solid. This process can be repeated several times. Following this step, the remaining solid is separated from the aqueous phase and is dried in air at a moderate temperature, typically about 60° C.

The metal oxide mesophase composition obtained in such a process in which molybdate is used as the ion exchange species exhibits, in its X-ray diffraction powder pattern, a single, somewhat broad low angle peak corresponding to a d-spacing of about 49 Å, and includes no peaks corresponding to molybdenum oxide crystals or to a discrete anatase phase. After calcination at 400° C., sharper peaks are observed corresponding to a spacing of from about 35 to 68 Å, depending on the temperature and the ratio of titanium to anionic surfactant utilised. The nitrogen sorption isotherm of such a material, after washing with 2 moles of molybdate per mole of anionic surfactant utilised, shows a type IV isotherm with substantially no hysteresis.

The present invention provides processes which are alternatives to the prior art processes for the preparation of transition metal oxide mesophase compositions, and which are relatively simple to use. The processes of the present invention utilise inexpensive reagents and are relatively simple to implement. The products obtainable by these processes have a unique surface functionalisation in which anionic species present, originating from the anionic surfactant used, are weakly bound to the pore system and can be easily replaced. This replacement can be achieved with simple procedures and leads to transition metal oxides with pore sizes below 35 Å. This is an important pore size range for catalytic applications.

The invention provides transition metal oxide mesophase compositions which can recognise and sorb a wide range of oxyanions, giving a convenient means for controlling the pore size of the metal oxide compositions and providing a means of achieving a high level of dispersion of a second metal oxide on a matrix of a first metal oxide. By appropriate choice of the metal oxides, such a combination can, for instance, produce an intimate atomic level coupling of two semiconducting oxides on the nanoscale (i.e. a semiconducting heterojunction.) Such a junction can have rectifying properties and can result in an improved matching of the bandgap of the metal oxide composition to the solar spectrum.

Applications for the transition metal oxide mesophase compositions include uses for ion exchange, including environmental applications of ion exchange such as removal of phosphates, arsenates, chromates and the like from waste or natural waters; as molecular sieves, for example for separations of gases or liquids; as electrode materials for high energy density batteries; in catalysis and photocatalysis, where (for example) the capability of matching the bandgap of the material to the solar spectrum permits efficiency improvements to be achieved, compared to existing photocatalytic methods for the destruction of organic pollutants; and as thin film sensors, and as battery electrodes. An additional important potential application is to use the anion exchange properties to introduce high loadings of anionic organo metallic complexes that are capable of being photo-oxidized. This gives rise to potential application in solar cell devices. For application in devices requiring coatings it will usually be desirable to deposit thin films of the transition metal oxide mesophase compositions of the invention on a substrate such as silica, silicon and the like.

It is possible to form films of the transition metal oxide mesophase compositions of the invention on various substrate materials by dip coating, spin coating, or other suitable means, from a viscous solution obtained after extensive hydrolysis of the transition metal oxide precursor(s) and just prior to gel formation. Such films can then be used in this form or ion-exchanged as described herein to provide coatings with potential opto-electronic applications as described above.

The invention will now be described in greater detail by reference to the following Examples, which are however not to be construed as in any way limiting the scope of the invention.

### EXAMPLES

### Example 1

Synthesis of Ti(III)-Dodecylsulfate Salt

To prepare the Ti(III)-dodecylsulfate salt precursor, 14.76 g of TiCl₃ was added to 50.0 mL of 2.0 mol/L HCl to give a solution that was 1.9 mol/L in Ti. Ten grams of this TiCl₃ solution (0.01474 mol Ti) was added with stirring to 27.6 mL of a solution of sodium dodecylsulfate (200 g/L). A lilac coloured precipitate formed immediately and after the mixture had been stirred for about 10 minutes, the precipitate was separated by centrifugation and the supernatant solution was discarded. Deoxygenated water was added to the lilac precipitate which was redispersed. After once again separating the precipitate by centrifugation it was freeze-dried. The resulting hygroscopic powder was stored and handled in a nitrogen purged glove box. Thermal analyses of powders prepared in this way gave a weight loss of between 90 and 93% using thermogravimetric analysis.

Assuming the weight loss to be entirely due to the volatilization of the dodecylsulfate component it is possible to calculate a chemical formula for the compound using the thermal analysis data. The average of ten such analyses on similarly prepared compounds gave the formula (C₁₂H₂₅SO₄)_{3.1}Ti so that the formula weight can be taken as 869.4 g/mol. Carbon and hydrogen analysis was consistent with this formulation and the FTIR spectrum showed the presence of SO₄ in these compounds.

### Example 2

Synthesis of Titanium Oxide Mesophase

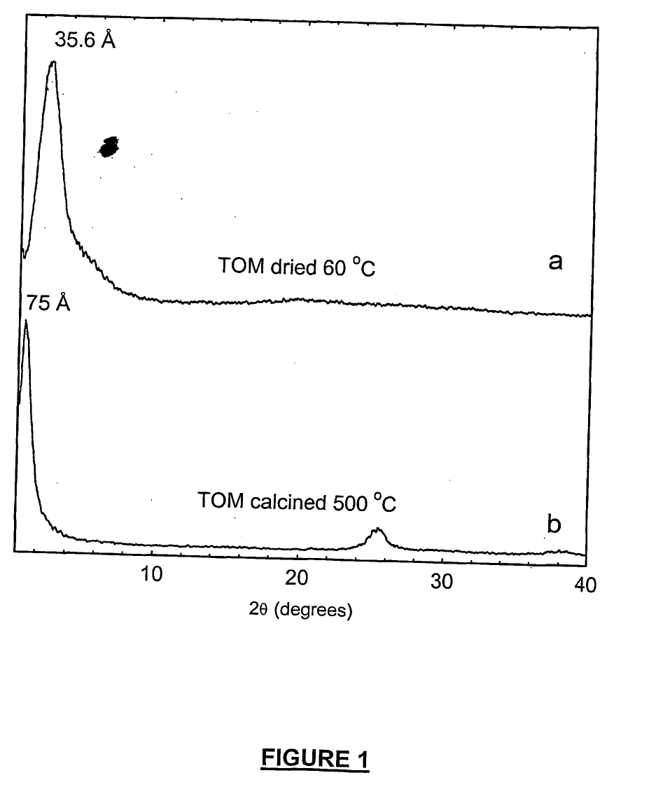

To prepare the titanium oxide mesophase, 0.364 g (0.00042 mol Ti) of the titanium(III) dodecylsulfate salt prepared by the method of Example 1 was added to 4.11 g (5.24 mL) ethanol and completely dissolved by warming to about 60° C. Then 0.982 g of titanium(IV) isopropoxide (0.00346 mol Ti; 1.02 mL) was added to give a Ti/dodecylsulfate ratio of about 3, and a burgundy coloured solution resulted. Water saturated nitrogen gas was bubbled into the burgundy solution contained within a glass vial. Water saturated air can also be used in this step. During this process the solution changed to a pale yellow colour and its volume was reduced to about half. Gelation was observed over a period of several hours. The transparent gel was dried in an oven at 60° C. and then ground in a mortar and pestle. The XRD pattern of the product is shown in FIG. 1a. A low angle XRD peak is observed and a weak shoulder can be discerned at slightly higher angles.

Direct calcination of the mesophase without first removing the surfactant and stablising the structure resulted in an increase in the d-spacing of the low angle peak from 36 Å before calcination to about 75 Å after calcination and the appearance of anatase in the XRD pattern. Transmission electron microscope images confirm that, without stabilising the mesostructure in some way, the transformation of the poorly ordered mesophase to crystalline titania particles occurs after direct calcination in air.

### Example 3

Variations in the Ti:Dodecylsulfate Ratio

This example is similar to Example 2, but the Ti:dodecylsulfate ratio is varied. Compounds were prepared by dissolving 1.833 g of titanium dodecylsulfate prepared as described in Example 1 (0.0021 mol Ti; 0.0065 mole dodecylsulfate) in each of three vials containing 20.0 g of absolute ethanol as described in Example 2. An additional 0.0141, 0.00884, and 0.00354 moles of Ti were added in the form of titanium(IV) isopropoxide to the three vials to give burgundy coloured solutions with Ti/dodecylsulfate=2.5, 1.7, and 0.9, respectively. These solutions were allowed to stand in ambient air at about 27° C. which facilitated the evaporation of alcohol and the infusion of moisture. The samples were then dried in an oven at 65° C. followed by the addition of 5 mL of water. The vials were incubated at the same temperature overnight until all of the liquid had evaporated to give dried powders. The samples with Ti/dodecylsulfate=2.5, 1.7, and 0.9 will be referred to herein as TOM-3, TOM-2, and TOM-1 respectively.

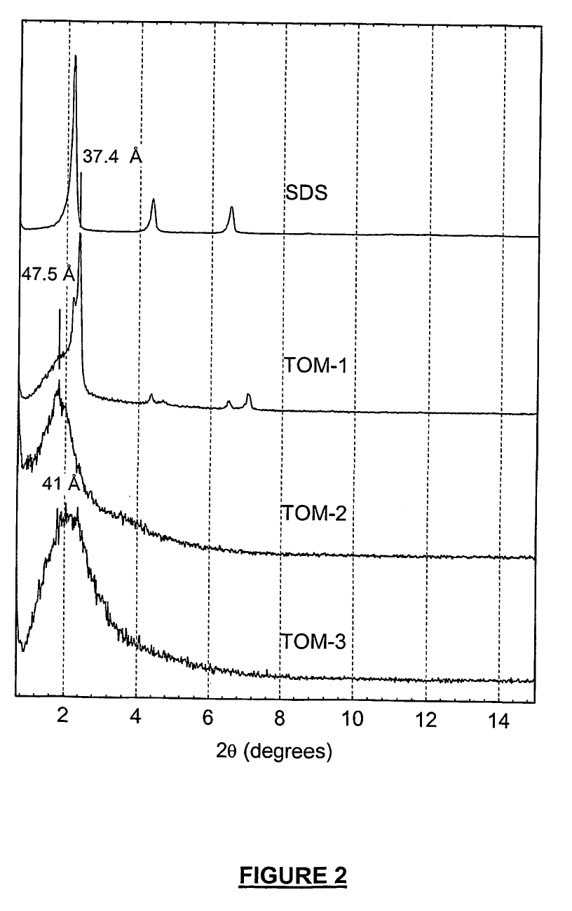

Low angle XRD patterns of the washed products are shown in FIG. 2. The product with x=0.9 (FIG. 2b), TOM-1, exhibits two intense sharp reflections at 2θ=2.2 (d=40.1 Å) and 2.36 (d=37.4 Å) degrees 2θ and a series of higher angle reflections that are harmonics of these primary reflections. This powder pattern is similar to that of sodium dodecylsulfate (SDS) shown in FIG. 2a and indicates that, like SDS, the TOM-1 product comprises mostly lamellar phases. In addition to the sharp reflections however, a broad reflection is observed at 2θ=1.86 (d=47.5 Å). Ordered lamellar phases are not observed in the powder pattern of TOM-2 (FIG. 2c). Instead, only the low angle broad component at 2θ=1.86 is observed in addition to a much weaker broad peak at around 2θ˜3.3 (d˜27 Å). If the most intense reflection is the (100) reflection of a hexagonal cell then the unit cell a-dimension should be given by a=2d/3^{1/2}=54.9 Å. This would then mean that the (110) reflection of a hexagonal cell should occur at d˜27 Å which is close to the spacing estimated for the broad weak peak.

The XRD pattern obtained for TOM-3 (FIG. 2d) contains a single weak low angle peak indicating that the degree of order is lower than for TOM-2. These XRD results show that significant amounts of poorly ordered surfactant-titania mesophases form when x is greater than or equal to about two. Such XRD patterns on their own are not sufficient to deduce ordered hexagonal or cubic mesophase formation as indexing of such patterns is meaningless. However, similar one-peak XRD patterns are observed in the silicate system when neutral surfactants are used (Tanev and Pinnavaia, Science, 267 865-867 (1995)). The low-angle peak observed in these patterns of FIG. 2 cannot be considered as a Bragg peak of lattice planes reflecting the center-to-center distance of small highly uniform cubic or hexagonally packed anatase (d₁₀₁=3.516 Å) or rutile (d₁₁₀=3.248 Å) particles that diffract coherently since there is no evidence of such titania phases in the high angle region of the XRD pattern.

The three uncalcined mesoporous titania compounds were examined by TEM. Large primary particles are observed for all samples investigated. While no fringes could be observed for TOM-1, in certain particle orientations a striated fringe pattern with a spacing of about 28 Å could be discerned in TOM-2. Similar striated fringe patterns are observed more often than hexagonal fringe patterns in TEM images of hexagonal OMS phases showing up to four XRD peaks. These striations have been attributed to the view at right angles to the hexagonal axis (Chenite, Le Page, et al., Chem. Mater. 7 1015-1019 (1995)). In other orientations a dappled fringe pattern is evident that is indicative of relatively poorly ordered pores. Similar fringes are often observed under certain diffraction conditions for MCM-41 phases possessing up to four XRD peaks, or more frequently, for poorly ordered MCM-41 (2-3 XRD peaks) (Ryoo et al., J. Phys. Chem. 100 17718-17721 (1996)). For samples with x≧2.5, only the dappled fringe pattern is usually observed. For example, the TEM images of an uncalcined TOM-3 sample shows ordering over 3-4 pore spacings. Thus, the tubular pores present in these samples are relatively poorly ordered and resemble surfactant sponge phases more than hexagonal materials. It is envisaged however, that in most applications, the ordering of the uniform tubular pores is unlikely to be important.

### Example 4

Titania as Major Component and Zirconia as Minor Component

In this example a zirconia - titania mesophase is synthesized using a method similar to the method described in Example 2, using titanium dodecylsulfate prepared as in Example 1 and a mixture of zirconium and titanium each in the tetravalent state. As has been described above, the metal in the higher oxidation state could also be any of a number of other metals, or mixtures thereof, added in the form of an alkoxide.

The preparation involved the dissolution of 3.0 g of titanium dodecylsulfate prepared as described in Example 1 in 38.9 g EtOH at 60° C. To the resulting solution was added 8.764 g of a mixed alkoxide solution containing Zr and Ti in a mole ratio of 1:2. The approximate metal/surfactant ratio was 3. The resulting red solution was placed in an incubator in which the temperature was controlled at 27° C. Moist (˜70% RH) air was passed through the incubator at a rate of about 300 cm³/min so as to cause slow hydrolysis of the alkoxides and evaporation of the various alcohols. During this process the mass of liquid was reduced from 50.10 g to 18.60 g and a gelatinous product was formed which was further dried in an oven at 70° C.

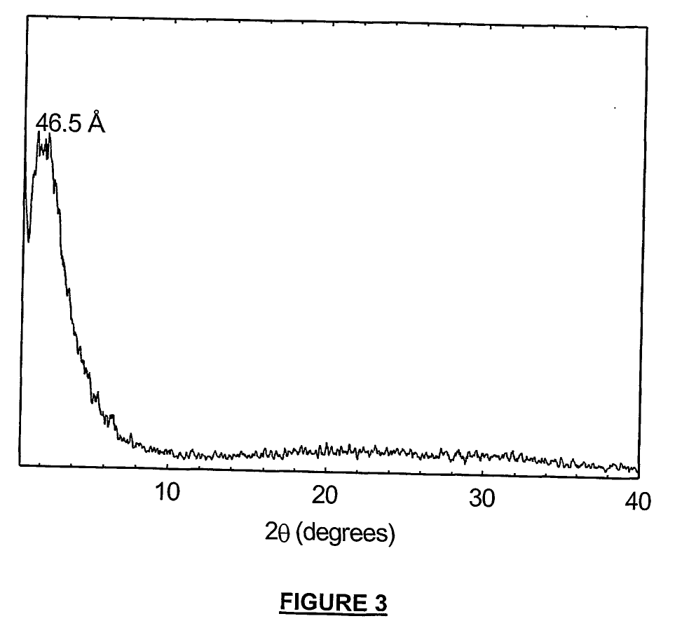

The dried solid gel was crushed and analysed by X-ray diffraction. The X-ray diffraction pattern obtained is shown in FIG. 3. Like the compounds described in Example 3, this material showed a single low angle diffraction peak with a d-spacing of 46.5 Å.

### Example 5

Template Removal with CH₃COONa

The sample with Ti/dodecylsulfate=1.7 of Example 3 was treated for removal of the anionic surfactant with sodium acetate solution in the following way. To 0.90 g of the titania mesophase was added 40.0 mL of a 1.0 M solution of sodium acetate and this was left in a sealed vial at 70° C. After standing overnight at this temperature, the mesophase was separated by vacuum filtration. Thermal analysis of the compound before and after surfactant removal showed that the sample weight loss had been reduced from about 62.5% prior to treatment with acetate to about 36.5% after treatment with acetate. Analysis of the same sample using energy dispersive X-ray analysis revealed that the S/Ti atomic ratio had decreased from about 0.24 to 0.027 confirming almost complete extraction of the sulfate component by this treatment. The remaining 28% weight loss of the extracted sample is due to the replacement of dodecylsulfate by CH₃COO⁻ which is itself quite volatile. Similar results could be achieved using lower acetate concentrations and omitting the incubation step.

### Example 6

Ion Exchange Using Inorganic Anions (MoO₄²⁻) and Modulation of Porosity

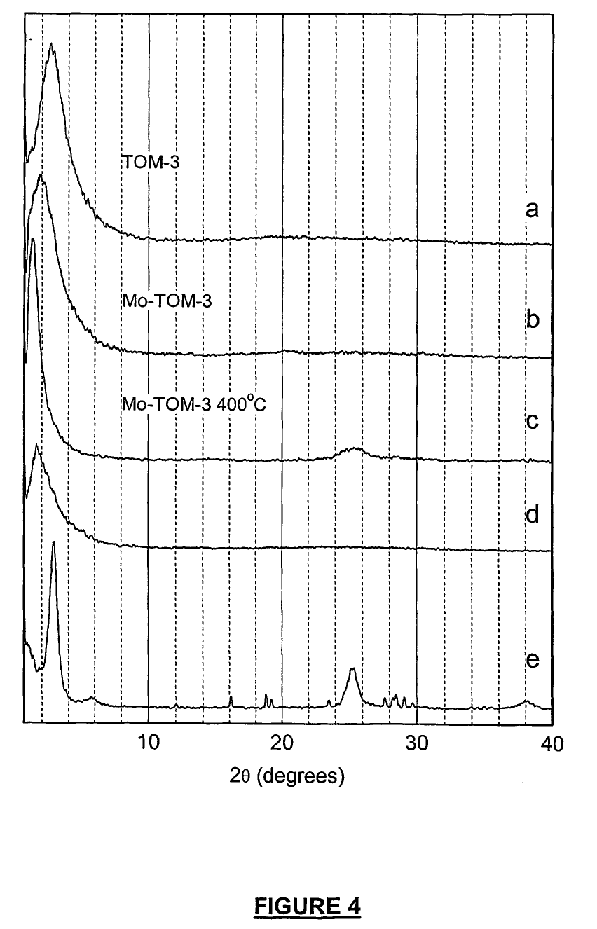

To 25.0 g of a solution of 40 mmol/L sodium molybdate was added 0.50 g of titania mesophase with Ti/DS˜3 made by the procedure of Example 2. The suspension, which had a pH of about 5.52, was stirred for about 2 hours and then the solid was separated by centrifugation. At this pH value the molybdate is expected to be present predominantly as MoO₄²⁻. Foaming of the supernatant was observed indicating surfactant release. The solid was redispersed by shaking with water and it was recovered once again by centrifugation. This step was repeated twice more and then the solid was dried in a 60° C. oven. A portion of this solid was calcined in air at 400° C. The XRD pattern of the titania mesophase is shown in FIG. 4a while the patterns of the uncalcined and calcined ion-exchanged samples are shown in FIGS. 4b and 4c. The ion exchange step does not significantly change the XRD pattern but calcination results in an increase in the d-spacing measured for the single low angle peak.

TEM analysis of the calcined exchanged sample indicated a disordered porosity with an inter-pore spacing of about 30 Å and an Mo distribution which varied from particle to particle. In general Mo deficient particles showed occasional evidence of 50-100 Å anatase particles using dark field imaging. Selected area diffraction confirmed the anatase crystal structure of these particles. Sample regions with high Mo concentrations showed disordered mesoporous morphology and no evidence of anatase crystallites.

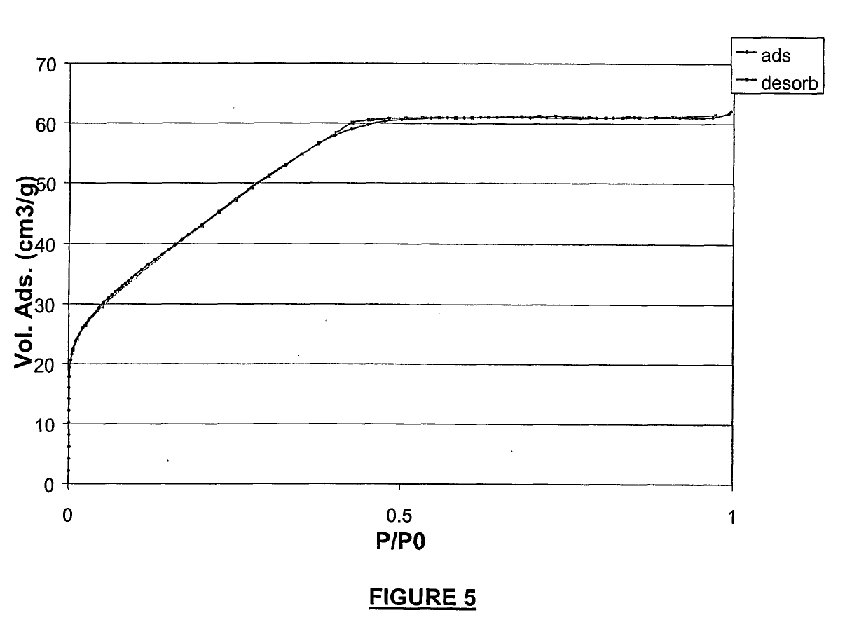

Nitrogen adsorption/desorption isotherms of the Mo-exchanged material are shown in FIG. 5. The BET surface area of this sample was 160 m²/g, the average pore diameter was determined using BJH theory to be 28.3 Å, and the pore volume was approximately 0.09 cm³/g.

This example shows that anion exchange using molybdate solution performs the dual function of removing the surfactant and stabilizing the mesostructure.

### Example 7

Ion Exchange Using Inorganic Anions (WO₄²⁻) and Control of Porosity

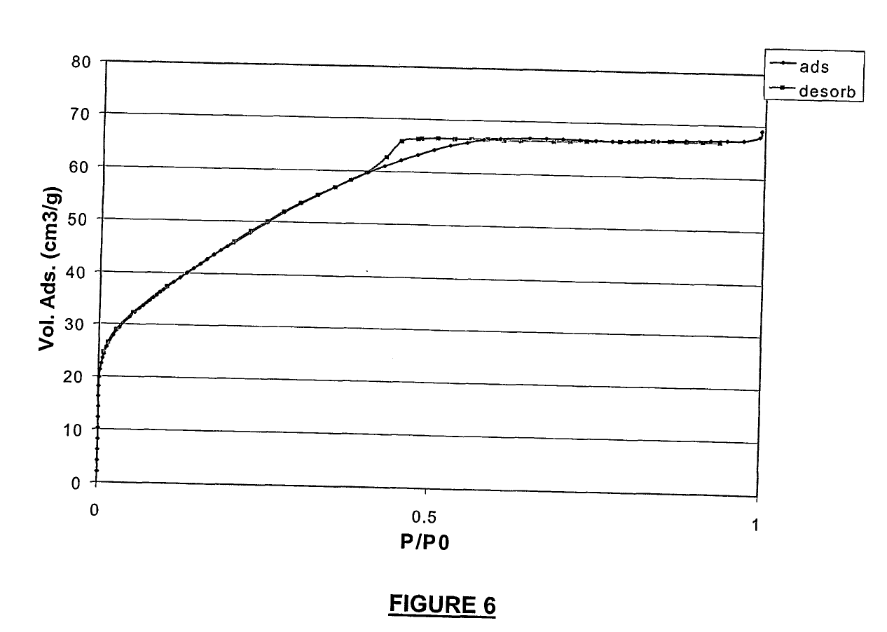

To 0.50 g of a titania mesophase with Ti/dodecylsulfate=3 made by the process of Examples 1 and 2 was added 25.0 mL of a solution of 40 mmol/L sodium tungstate and this was stirred for about 1 h. Surfactant release was noted by the presence of foam above the solution. The pH of the suspension during the exchange reaction was 5.5. After calcination at 400° C. in air a similar isotherm (shown in FIG. 6) was obtained as for Example 6 and from this a BET surface area of 171 m²/g was calculated and an average pore diameter of 30.3 Å was obtained using the BJH theory.

### Example 8

High Molybdate Concentrations

In a similar procedure to that of Example 6, a 0.50 g sample of the titania mesophase with Ti/dodecylsulfate=3 was added to 50 mL of 200 mmol/L sodium molybdate solution. After the mixture had been stirred for 1 h the solid was separated by centrifugation and washed by repeatedly shaking with milli Q water followed by centrifugation. The BET surface area of this sample after calcination in air at 400° C. for 1 h was about 5 m²/g. This shows that after initial exchange of the surfactant molecules from the pore spaces of the titania using high concentrations of oxyacid, these pores then become blocked with excess molybdate.

### Example 9

Ion Exchange at Different pH Values

In this example the dodecylsulfate attached to the titania mesophase is exchanged for MoO₄²⁻ after first adjusting the pH to a value at which MoO₄²⁻ is known to be the predominant molybdate speciation. A 1.50 g sample of the titania mesophase was added to each of five different flasks and then 50 mL of water was added. The pH of the resulting suspensions was typically around 2.2. The pH was adjusted to between 6.5 and 7.5 using 0.5 M NaOH solution and then 0, 0.53, 1.05, 2.14 and 4.34 g of 1.0 M sodium molybdate solution was added to give solutions with pH in the range 6.8 to 7.7. After stirring for about 2 h, the solids were separated by centrifugation, washed three times and dried at 70° C. Elemental ratios were determined and are presented in Table 1.

TABLE 1

Atomic Ratios

| g molybdate solution | pH | Mo | Na | Ti | S |
|---|---|---|---|---|---|
| 0 | 7 | 0.002 | 0 | 0.98 | 0.02 |
| 0.53 | 6.8 | 0.047 | 0.043 | 0.90 | 0.009 |
| 1.05 | 7 | 0.071 | 0.049 | 0.88 | 0.00 |
| 2.14 | 7.4 | 0.067 | 0.043 | 0.89 | 0.0 |
| 4.34 | 7.7 | 0.084 | 0.082 | 0.8 | 0.005 |

This example shows that the dodecylsulfate can be completely removed from the mesophase and replaced predominantly by anionic molybdate species. It is to be noted that Na⁺ also becomes adsorbed on the titania mesophase surfaces.

### Example 10

Sorption of Vanadate (VO₄²⁻) and Comparison With Other Titanates

To 1.0 g samples of titania mesophase produced by the method of Example 2 and hydrous amorphous titania (“HTO”) synthesized through the hydrolysis of titanium(IV) isopropoxide was added 83.0 mL of 40 mM sodium vanadate to give a solution with pH of 12 or over. In a parallel set of experiments 83.0 mL of 40 mM sodium molybdate was added to each of 1.0 g of the titania mesophase and the HTO. The pH of each of the resulting suspensions was adjusted to 12.

TABLE 2

| | | Atom Ratios | | | | |
|---|---|---|---|---|---|---|
| Sample | pH | V | Mo | Na | Ti | S |
| titania mesophase + | 12.2 | 0.069 | | 0.15 | 0.78 | 0.0065 |
| VO₄²⁻ | | | | | | |
| HTO + VO₄²⁻ | 12.2 | 0.019 | | 0.046 | 0.93 | 0.0024 |
| Titania mesophase + | 12.0 | 0 | 0.009 | 0.14 | 0.86 | 0.0056 |
| MoO₄²⁻ | | | | | | |
| HTO + MoO₄²⁻ | 12.0 | 0 | 0 | 0.061 | 0.94 | 0.0026 |

The results of Table 2 indicate that the capacity of the titania mesophase to sorb VO₄²⁻ was much greater than that of the HTO material and neither exchanger could sorb significant amounts of Mo from solutions with such high pHs.

### Example 11

Chromate (CrO₄²⁻) Sorption

Chromium in the hexavalent oxidation state is a known to have carcinogenic properties and therefore the sorption of Cr⁶⁺ in the form of the CrO₄²⁻ oxo-anion from the environment has important public health implications. In this example the sorption of CrO₄²⁻ by the titania mesophase is demonstrated. To about 0.40 g of the titania mesophase prepared as described in Example 2 were added 15 mL of solutions with increasing concentrations of chromate. The chromate solutions were prepared by dilution of 10 and 40 mM chromate solutions using sodium hydroxide to adjust the pH to values between 11.3 and 15. The pH adjustment step was necessary to ensure that the hexavalent chromium ion remains as CrO₄²⁻ without converting to HCrO₄⁻ or Cr₂O₇²⁻ which can occur at lower pH values.

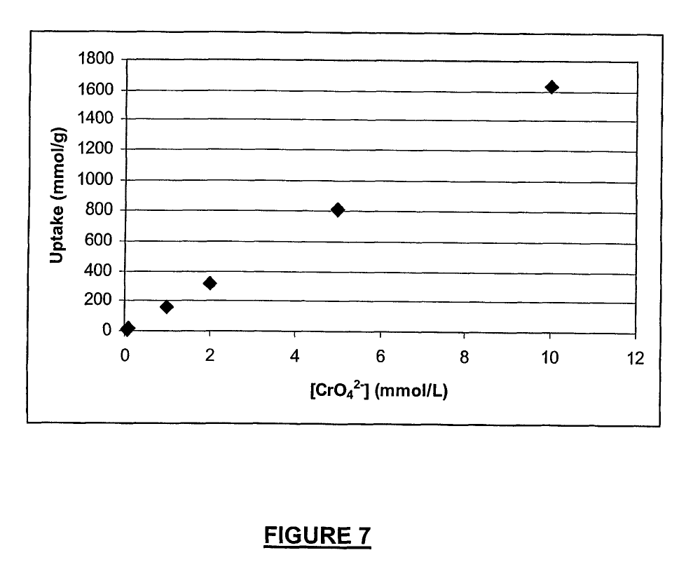

The chromate adsorption results are shown in FIG. 7 and demonstrate that the titania mesophase material has a significant capacity for the sorption of chromate over the concentration range studied. It can be concluded that concentrations well in excess of 10 mmol/L at the present liquid:solid ratio would be required to cause saturation of adsorption sites or the titania by chromate.

### Example 12

Comparison of Cation Exchange Capacity With Other Titanates

This example tests the sorption capacity of the titania mesophase and compares it to that of other similarly treated titanates.

1. Titania mesophase—this was produced according to the method of Example 2.

2. Hydrous amorphous titania—as produced by the method described in Example 10.

3. Nanocrystalline rutile—prepared by the method of Anpo et al., J. Phys. Chem. 91, 4305-4310 (1987)). In this method 40.0 mL of TiCl₄ was added slowly to 1000 mL of water in which 40 mL of concentrated HCl had been dissolved (pH=0.62). During addition of the TiCl₄ the water was maintained at 0° C. and was stirred rapidly. The solution was maintained at 333 K for 3 h, cooled to 290 K and kept at this temperature for 15 h. The precipitate was removed by vacuum filtration and air-dried. This material had an average particle size of 52 Å.

4. Dodecylamine titania mesophase—produced by the addition of 6.82 g of titanium(IV) isopropoxide to warm dodecylamine in a mole ratio of 1:1 to give a homogenous liquid precursor which was then added directly to about 30 mL of water with stirring. The resulting white precipitate was separated by vacuum filtration and then dried in a 60° C. oven.

5. Stearic acid titania mesophase—prepared by the addition of 4.26 g (0.015 mol) of titanium(IV) isopropoxide to a solution of 1.422 g (0.005 mol) of stearic acid dissolved in 20.0 mL of isopropanol. About 30.0 mL of water was added to this mixture to give a thick white precipitate which was separated by vacuum filtration, washed extensively and dried in a 60° C. oven. This material gave a low-angle X-ray spacing at 34.0 Å and an additional reflection with a spacing corresponding to 21.2 Å.

To 0.50 g of each of the titania phases described above was added 20.0 mL of 0.10 mol/L copper nitrate solution and the solutions were left to stand for several hours with occasional agitation. The solids were then analysed for Cu by neutron activation analysis and the results are presented in Table 3.

TABLE 3

| Titania sample | μg Cu/g sample |
|---|---|
| 1 | <130 |
| 2 | 3300 |
| 3 | 6300 |
| 4 | 55000 |
| 5 | 4600 |

These results indicate that while the titania mesophase of the present invention has a strong affinity for anionic species, its capacity to sorb cations such as Cu(II) is much lower than that of particulate-based titania nanophases (2 and 3) and other surfactant-containing titania mesophases.

### Example 13

Large Organic Anion Sorption

This example was designed to test the ability of the titania mesophase of the present invention to sorb significant quantities of large organic anions. In this case the organic anion is 4-(2-hydroxyl-1-naphthylazo)benzenesulfonic acid, also known as Orange II. This is a pH indicator dye and is intensely coloured. To about 40 mg of each of mesophases 1 and 4 of Example 12, and a titania mosphase made from 1,2-hexadecanediol, was added about 5 mL of an aqueous solution of Orange II. Only the titania mesophase of the present invention sorbed visible quantities of the anionic dye and the amount was great enough to impart an intense colour to the dried gel. Infrared spectra of Orange II sorbed on the mesophase showed similar bands to those present in an Orange II solution but broadened significantly and with modulated intensities. This may be indicative of the interaction with the mesophase surfaces.

A quantitative comparison of Orange II uptake by a titania mesophase (x˜3) with that of hydrous amorphous titania (HTO) having a surface area of 148 m²/g showed that while 0.5 g of the titania mesophase was able to sorb all of the Orange II from 5 mL of 5.0 mM aqueous Orange II solution (>0.051 mmol OrangeII/mmol Ti uptake) the HTO sorbed only a fraction of the total Orange II (0.0096 mmol OrangeII/mmol Ti uptake).

### Example 14

Quantitative Measure of Orange II Uptake on Titania Mesophase Compared With P25

In this example we compare in a quantitative manner the capacity to sorb Orange II of the titania mesophase prepared as described in Example 2 and a reference titania sample marketed by Degussa Chemical Company under the trade name P25. The P25 material is comprised of a mixture of anatase and rutile and has a surface area of about 50 m²/g. Samples of the two titania materials (0.50 g) were treated with 5.0 mL of aqueous solutions of Orange II with concentrations in the range 1.0 to 50.0 mmol/L. The amount of Orange II remaining in solution was quantified by measurement of the optical absorbance of the solution and comparison with Orange II standard solutions.

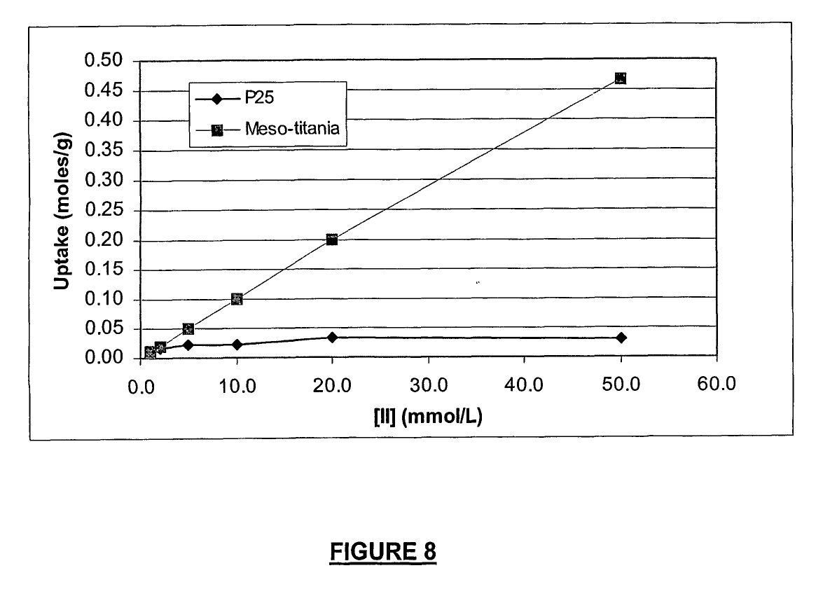

The data plotted in FIG. 8 shows that the capacity of the titania mesophase to take up Orange II is at least an order of magnitude greater than that of the P25 standard material. The data also show that whereas the P25 becomes saturated when the concentration of Orange II reaches 20 mmol/L, the titania mesophase continues to sorb in a linear fashion even beyond an Orange II concentration of 50 mmol/L. It should be noted that the titania mesophase was used as-prepared without removing the surfactant and hence the amount of titanium in the sample is very small. This implies that the sorption capacity in terms of mmol Orange II per g TiO₂ is well in excess of an order of magnitude greater than that of P25.

A similar experiment carried out using the mixed titania/zirconia mesophase described in Example4 produced essentially identical results. That is, the sorption of Orange II by the mixed mesophase was essentially the same as the sorption of Orange II by the titania mesophase of Example 2.

### Example 15

Desorption of Orange II

Example 14 demonstrates that the titania mesophase has a strong affinity for large organic dye molecules containing sulfonate functionalities. In this example we demonstrate how these adsorbed molecules can be desorbed by contacting with dilute alkali solutions. Moreover, the rate of desorption depends in a sensitive manner on the drying regime to which the titania mesophase containing sorbed Orange II is subjected.

A sample of 4.3 mg of titania mesophase containing Orange II was placed in a plastic cuvette and 3.13 mL of 0.10 M NaOH solution was added. At intervals the cuvettes were stoppered and agitated briefly. The solid was then allowed to settle and the optical absorbance of the supernatant solution was measured. The optical absorbance measurement is proportional to the concentration of Orange II released to solution.

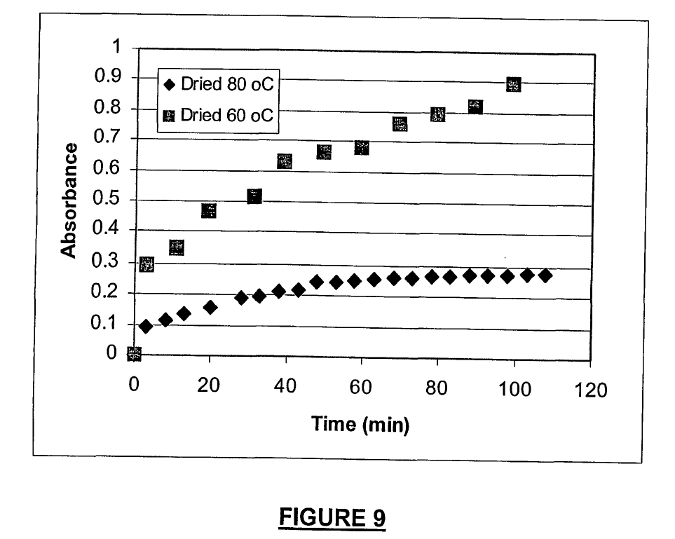

Absorbance measured as a function of time after addition of the NaOH solution is shown in FIG. 9 for samples of Orange II containing titania mesophase dried at 60 and 80° C. Even a 20° C. temperature difference is sufficient to give quite different desorption profile with the sample dried at 60° C. desorbing the Orange II at a much faster rate.

### Example 16

Film Formation

Many important technological applications of the titania materials rely on the ability to prepare the material in the form of thin films. We exemplify here one of several possible methods of forming films of the titania mesophase. The film forming process used a titania mesophase gel as prepared in Example 2.

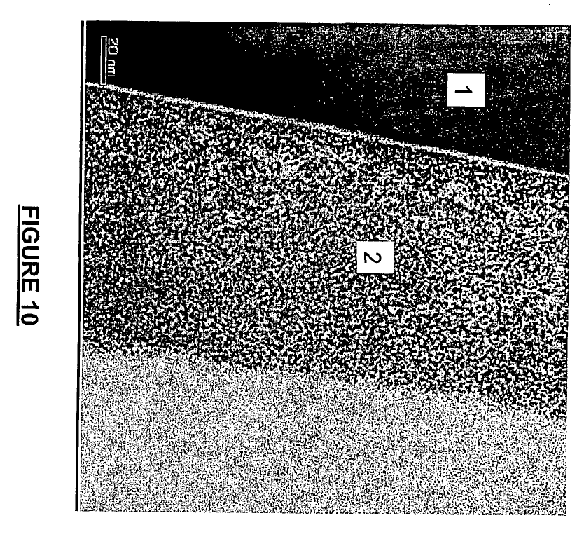

The preparation involved the dissolution of 5.225 g Ti dodecylsulfate precursor in 67.74 g EtOH at 60° C. To the resulting solution was added 12.55 g of Ti-isopropoxide. The approximate metal/surfactant ratio was 3. The resulting red solution was placed in an incubator in which the temperature was controlled at 27° C. Moist (˜70% RH) air was passed through the incubator at a rate of about 300 cm³/min so as to cause slow hydrolysis of the alkoxide and evaporation of the various alcohols. The volume of the gel solution was reduced to about half its initial volume without being allowed to solidify. This solution was then used for dip coating. Silicon slides were dipped into the gel solution and withdrawn at a rate of 5 cm/min in ambient air (40% RH). A TEM image of a cross-section of the uncalcined film is shown in FIG. 10. The typical film thickness was about 113 mn and the disordered mesoporous structure 2 on silicon substrate 1 is apparent at this magnification. Calcination of the films at 450° C. in air removes the surfactant leaving a sulfate containing titania mesoporous material with essentially similar mesostructure to the uncalcined material.

### Example 17

Structure of a Crystalline Intermediate Obtained in the Preparation of Titania Mesophase

An intermediate crystalline compound was isolated during the synthesis of titania mesophase material with a molar ratio of Ti to surfactant of about 3.

Ti(III)-dodecylsulfate was synthesized as described in Example 1. The dried salt was dissolved in anhydrous ethanol by warming to about 60° C. and then titanium(IV) isopropoxide was added to give a Ti/dodecylsulfate ratio of 3. Addition of the isopropoxide gave rise to a burgundy-coloured solution which was incubated for several hours at about 70° C. The burgundy coloured solution was then exposed to ambient air for about four hours until the colour faded due to oxidation of Ti³⁺ to Ti⁴⁺. The reaction vessel was then sealed and on standing for several months, large colourless crystals formed, which were isolated under N₂ and washed with dry ethanol. The yield of the crystalline material was about 4wt %.

The crystal structure of the crystalline compound was solved and showed a cluster of eight titanium atoms and two sulfate groups in the unit cell, with bonding of the SO₄²⁻ group to the titanate cluster core being through the three basal oxygen atoms of the SO₄²⁻ tetrahedron.

It can be expected that the manner in which the sulfate is bound in the titanate cluster would have been preserved in the titanate mesophase if the hydrolysis reaction had been allowed to proceed to completion. As has been demonstrated in Examples 5-11 and 13, and as disclosed herein, once the mesophase is formed the surfactant is exchangeable. However, once the surfactant is removed it must leave titanium-containing polyhedra that are coordinatively unsaturated. That is, the sulfate head group leaves an imprint of itself on the titanate framework of the mesophase. The vacant coordination positions can be filled by other anions, and are best filled by oxo anions that have a similar geometry to sulfate. The replacement of sulfate by transition metal oxo anions of similar structure can be expected to add to the thermal stability of the transition metal oxide framework.

The FTIR spectrum of the intermediate crystalline compound prepared as described above, compared to the spectrum of sodium dodecylsulfate, shows the stretching vibrations of the sulfate group shifted to higher frequencies. This perturbation of the stretching vibrations of the sulfate is evidence of enhanced bonding of the sulfate to a small number of titanium atoms in the cluster.

Vibrations around 800 cm⁻¹ are observed in the crystalline intermediate and are assigned to Ti—O—Ti. As expected this vibrational mode is also observed in the titania mesophase obtained as described in Example 2, since there has been an increase in the condensation of Ti polyhedra. In comparison, there is only negligible intensity around 800 cm⁻¹ in the FTIR spectrum of the titanium dodecylsulfate salt, confirming that the number of oxo bonds is small in this compound.

The FTIR spectra suggest that the sulfate bonding in the mesophase is relatively weak, which is consistent with the easy replacement of the surfactant that is described herein. However, FTIR does not definitively show that the bonding of sulfate in the cluster is exactly the same as that of the mesophase. Nevertheless, there are only a limited number of ways in which the sulfate of ROSO₃²⁻ surfactants can coordinate to titanium, namely through one, two or three oxygen atoms. The present work shows that coordination by all three oxygen atoms actually occurs in the cluster. Since the crystal structure of the cluster shows a titanium-oxygen network similar to that expected for the framework of the mesophase, a similar coordination of sulfate in the mesophase can be inferred.

1. A process for preparing a transition metal oxide mesophase composition including converting a transition metal oxide precursor into a transition metal oxide in the presence of a sulfur-containing anionic surfactant templating agent under conditions effective for the formation of a transition metal oxide mesophase including said anionic surfactant, said process further including replacing at least part of said anionic surfactant in said transition metal oxide mesophase with an anion of one or more oxyacids of one or more metals selected from elements from group Va, VIa, VIIa, VIIIa, IIIb, IVb, Vb and VIb of the periodic table.

2. A process according to claim 1, wherein said sulfur-containing surfactant has a sulfate anionic head group.

3. A process according to claim 1, wherein said sulfur-containing surfactant is an alkyl sulfate.

4. A process according to claim 1, wherein the transition metal is a metal selected from the group consisting of Ti, V, Cr, Mn, Fe, Zr, Nb, Mo and W.

5. A process for preparing a titanium oxide mesophase composition including converting a titanium oxide precursor into a titanium oxide mesophase composition in the presence of a templating agent under conditions effective for the formation of a titanium oxide mesophase, wherein the templating agent includes a sulfur-containing anionic surfactant, said process further including at least partially removing said anionic surfactant from said titanium oxide mesophase composition by ion exchange.

6. A process according to claim 5, wherein said sulfur-containing surfactant has a sulfate anionic head group.

7. A process according to claim 5, wherein said sulfur-containing surfactant is an alkyl sulfate.

8. A process for preparing a transition metal oxide mesophase composition including forming a mixture of a first transition metal oxide precursor which includes said transition metal in a first oxidation state X, a sulfur-containing anionic surfactant, and a second transition metal oxide precursor including a transition metal in a second oxidation state Y, wherein X and Y are different, and converting the transition metal oxide precursors to transition metal oxide under conditions effective to form said transition metal oxide mesophase composition.

9. A process according to claim 8, wherein said sulfur-containing surfactant has a sulfate anionic head group.

10. A process according to claim 8, wherein said sulfur-containing surfactant is an alkyl sulfate.

11. A process according to claim 8, wherein the difference between X and Y is +2, +1 or −1.

12. A process according to claim 8, wherein the transition metals in oxidation states X and Y are the same.

13. A process for preparing a transition metal oxide mesophase composition including forming a solution in an organic solvent of a first transition metal oxide precursor including a transition metal in a first oxidation state X, a sulfur-containing anionic surfactant, and a second transition metal oxide precursor including a transition metal in a second oxidation state Y, wherein X and Y are different, converting the transition metal oxide precursors to transition metal oxide under conditions effective to form a transition metal oxide mesophase including said anionic surfactant, and at least partially removing the anionic surfactant from the transition metal oxide by ion exchange to form the transition metal oxide mesophase composition.

14. A process according to claim 13, wherein said sulfur-containing surfactant has a sulfate anionic head group.

15. A process according to claim 13, wherein said sulfur-containing surfactant is an alkyl sulfate.

16. A process according to claim 13, wherein the difference between X and Y is +2, +1 or −1.

17. A process according to claim 13, wherein the transition metals in oxidation states X and Y are the same.

18. A process according to claim 5, wherein the anionic surfactant is removed by ion exchange with a solution of one or more oxyacids of metals from group Va, VIa, VIIa, VIIIa, IIIb, IVb, Vb and VIb of the periodic table, or a salt thereof.

19. A process according to claim 18, wherein the oxyacid is an oxyacid of a transition element.

20. A process according to claim 13, wherein the anionic surfactant is removed by ion exchange with a solution of one or more oxyacids of metals from group Va, VIa, VIIa, VIIIa, IIIb, IVb, Vb and VIb of the periodic table, or a salt thereof.

21. A process according to claim 20, wherein the oxyacid is an oxyacid of a transition element.

22. A transition metal oxide mesophase composition when prepared by the process of any one of claims 1-21.

23. A transition metal oxide mesophase including titania as a major component, said metal oxide mesophase exhibiting an X-ray diffraction pattern which contains at least one peak and being capable of sorbing at least about 0.02 atoms of a transition element per atom of titanium when contacted with a solution containing anions of an oxyacid of said transition element, at a pH at which said anions are substantially monomeric.

24. A transition metal oxide mesophase composition including a first transition metal oxide and a lesser amount of a second transition metal oxide dispersed on said first metal oxide, which transition metal oxide mesophase exhibits an X-ray diffraction pattern which contains at least one peak and is thermally stable to at least 400° C.

25. A transition metal oxide mesophase composition including a sulfur-containing anionic surfactant.

26. A transition metal oxide mesophase composition according to claim 25, wherein said sulfur-containing surfactant has a sulfate anionic head group.

27. A transition metal oxide mesophase composition according to claim 26, wherein said sulfur-containing surfactant is an alkyl sulfate.

28. A transition metal oxide mesophase composition according to claim 25, wherein the transition metal oxide is titania or a mixed oxide comprising titania as a major component.

29. A transition metal oxide mesophase composition according to claim 25, wherein the transition metal oxide is titania.

30. A process for at least partially removing anions from an aqueous solution of said anions, comprising contacting said aqueous solution with a transition metal oxide mesophase composition according to any one of claims 23-29 for a time sufficient to decrease the concentration of said anions in said aqueous solution.

31. A process according to claim 30, wherein said anions are selected from the group consisting of sulfate, phosphate, borate, aluminate, molybdate, vanadate, tungstate, chromate, formate, acetate, propionate, butyrate, anions derived from organic dyes, ferrocyanide, ferricyanide, Au(CN)₂⁻ and Au(Cl)₂⁻.
